(19) United States
(12) Patent Application Publication
(10) Pub. No.: US 2009/0274287 A1
(43) Pub. Date: Nov. 5, 2009

(54) System and method for blocking mobile phone calls and messages

(76) Inventor: Hussain Nasser Al-Duwaish, Dhahran (SA)

Correspondence Address: LITMAN LAW OFFICES, LTD., POST OFFICE BOX 15035, CRYSTAL CITY STATION, ARLINGTON, VA, 22215-0035, US

(21) Appl. No.: 12/149,384

(22) Filed: Apr. 30, 2008

(51) Int. Cl. H04M 3/42

(52) U.S. Cl. 379/207.03

(57) ABSTRACT

The mobile phone blocking system and method includes a worldwide prayer time database accessible to mobile phone service provider equipment. Electronic circuitry may be included for comparing local time of the mobile phone to a devotional prayer time in the worldwide prayer time database, wherein a comparison between the mobile phone local time and the devotional prayer time is made. Electronic circuitry is provided for interrupting mobile telephone service to the mobile phone based on a comparison result. If the mobile phone has an incoming call when the mobile telephone service is interrupted by the mobile telephone service interrupt electronic circuitry, the mobile phone is kept in a non-audible, non vibratory, non-visually distracting, standby mode and the incoming call is diverted to an electronic mail box accessible to the user, thus allowing the user of the mobile phone to continue devotional activities without being interrupted by the incoming call.

### BACKGROUND OF THE INVENTION

1. Field of the Invention

The present invention relates to cellular and mobile phone control systems, and particularly to a system and method for blocking mobile phone calls and messages during the prayer times of Muslims.

2. Description of the Related Art

Muslims need to perform prayers five times a day in Mosques. Prayer times are known in advance for any time in the future and in any location in the world. In order not to disturb the prayers, people have to switch off their mobile or cellular phones before entering the Mosque. Some people forget to switch off their mobile phones, or they assume nobody will call them during the prayer. The audible ringtone of a cellular or mobile telephone during prayer times disturbs others in the Mosque in the case of an incoming call.

While there have been other attempts at phone interrupt programs based on prayer and devotional times, such attempts usually have involved loading the cellular or mobile telephone with additional software and or databases, which may overload the phone, or the phone may have insufficient memory or processing capability to accommodate the database and control software.

Thus, a system and method for blocking mobile phone calls and messages solving the aforementioned problems is desired.

### SUMMARY OF THE INVENTION

The system and method for blocking mobile phone calls includes a worldwide prayer time database accessible to cellular or mobile phone service provider equipment. Electronic circuitry in the service provider's equipment may be included for comparing the local time of the mobile phone to a devotional prayer time in the worldwide prayer time database, so that a comparison between the mobile phone local time and the devotional prayer time is made. Electronic circuitry in the service provider's equipment provides a time-based control protocol through which mobile telephone service to the mobile phone may be interrupted, based on the time comparison results. If the mobile phone has an incoming call when the mobile telephone service is interrupted by the mobile telephone service interrupt electronic circuitry, the mobile phone is kept in a non-audible, non vibratory, non-visually distracting standby mode, and the incoming call is diverted to an electronic mail box accessible to the user, thus allowing the user of the mobile phone to continue devotional activities without being interrupted by the incoming call.

These and other features of the present invention will become readily apparent upon further review of the following specification and drawings.

### BRIEF DESCRIPTION OF THE DRAWINGS

FIG. 1A is a block diagram of a system for blocking mobile phone calls and messages according to the present invention.

FIG. 1B is a block diagram of a mobile phone system, showing details of the system for blocking mobile phone calls and messages according to the present invention.

FIG. 2 is a flowchart showing the steps of a method for blocking mobile phone calls and messages according to the present invention.

Similar reference characters denote corresponding features consistently throughout the attached drawings.

### DETAILED DESCRIPTION OF THE PREFERRED EMBODIMENT

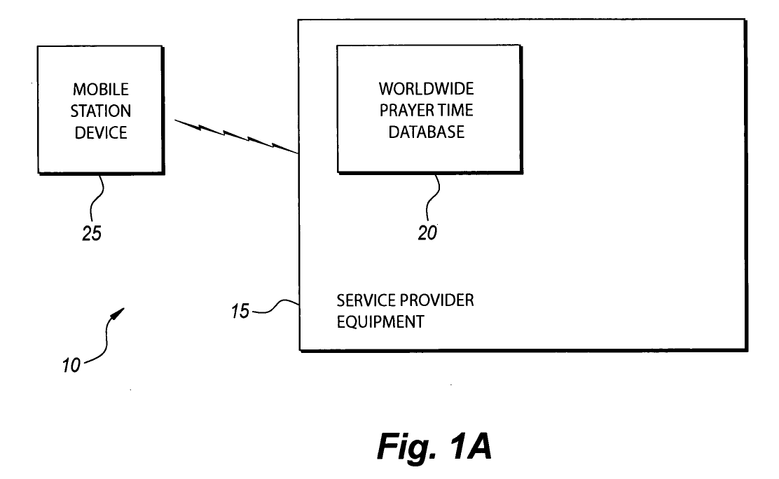

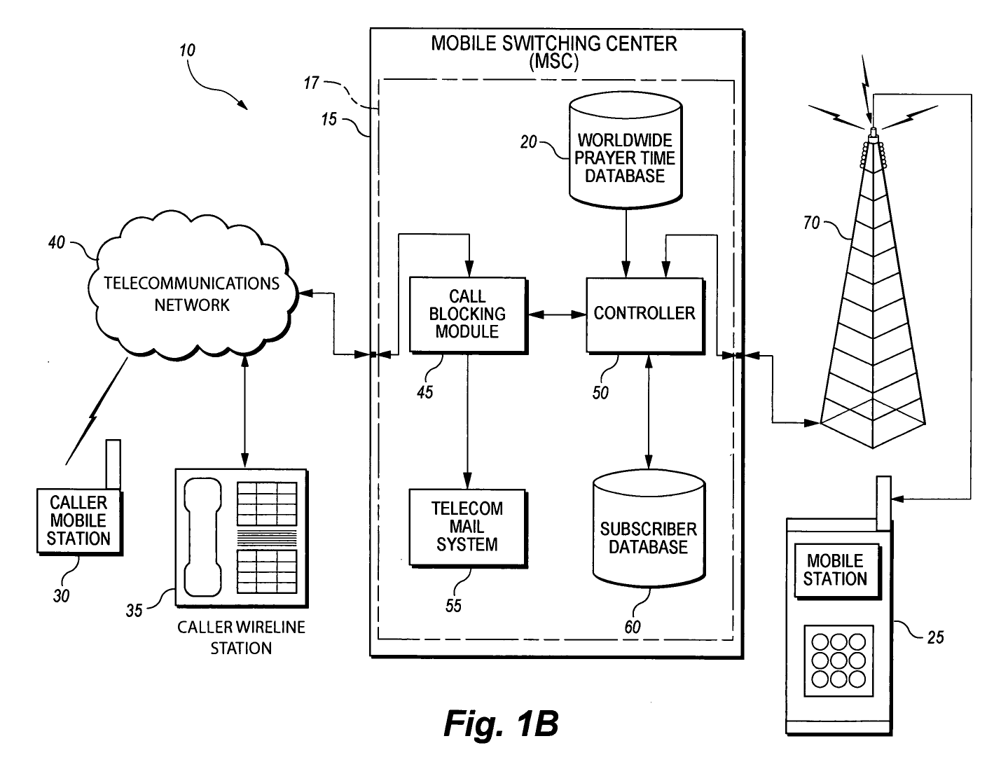

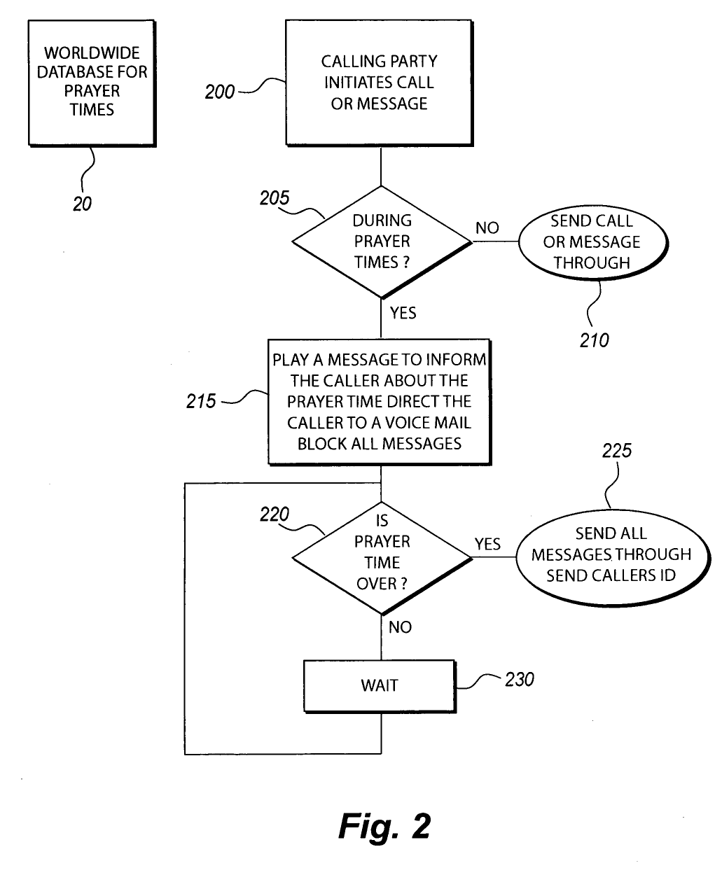

As shown in FIGS. 1A, 1B, and 2, the present invention is a call blocking system 10 that includes a worldwide prayer time database 20 accessible to cellular or mobile phone service provider equipment 15 in communication with a mobile station 25, e.g., a mobile or cellular telephone, a smartphone, or the like. As most clearly shown in FIG. 1B, the mobile phone service provider equipment 15 preferably comprises a Mobile Switching Center 17 (MSC) capable of accessing base station 70 for connecting a calling party's mobile station 30 or wireline station 35 to subscriber mobile station 25.

A call blocking controller 50 within MSC 17 is connected to a first mass storage unit, such as subscriber database 60, and a second mass storage unit, such as world wide prayer time database 20. Call blocking module 45 selectively blocks calls and/or messages coming from caller mobile station 30 or caller wireline station 35 over telecommunications network 40.

For any given subscriber, the call blocking module 45 is activated based on control signals from the call blocking controller 50. The worldwide prayer time database 20 is comprised of devotional prayer times. If mobile station 25 is subscribed to the prayer time phone blocking service a registration entry is made in the subscriber database 60. Worldwide prayer times are checked versus the mobile user's local time for call blocking only if a registration entry exists in subscriber database 60 for mobile station 25.

As is well understood by one having ordinary skill in the art, the location of mobile station 25 is continuously updated and known by MSC 17 based on which cell site, i.e., base station 70, the mobile station 25 is accessing. Moreover, it should be well understood that the local time of base station 70 is always available to the MSC 17.

Due to the fact that mobile station 25 is presumed to be in relatively close proximity to base station 70, the local time of mobile station 25 may be assumed to be the same as local time of base station 70. Thus, for subscribers to the service offered by system 10, the local time of base station 70 is used by the call blocking controller 50 for comparing the local time of the mobile phone 25 to the devotional prayer time (for that time location) in the worldwide prayer time database 20. Electronic circuitry in call blocking controller 50 provides a time-based control protocol through which mobile telephone service to the mobile station 25 is interrupted based on the time comparison results.

If, as determined by call blocking controller 50, the local time reported by base station 70 is within the devotional prayer time in database 20, a call blocking signal is sent from the call blocking controller 50 to the call blocking module 45. The call blocking module 45 blocks the call from reaching base station 70 for relay to mobile station 25 and instead diverts the call to telecommunications mail system 55. Telecommunications mail system 55 may include processors and memory storage units equipped to process and store a plurality of messages and message types (such as e-mail messages, voice messages, text messages, multimedia messages, or the like) initiated by caller mobile station 30 or caller wireline station 35 and diverted to telecommunications mail system 55 by call blocking module 45.
Moreover, telecommunications mail system 55 preferably includes standard pre-recorded or custom pre-recorded voice, text, or multimedia messages that are sent to caller mobile station 30 or caller wireline station 35 to inform the caller that his/her call/message is being temporarily diverted to the telecommunications mail system 55 until the recipient's prayer and/or devotional time is over. Once the recipient's prayer and/or devotional time is over, MSC 17 can route the messages stored in telecommunications mail system 55 to base station 70 for relay to recipient's mobile station 25.

The processing steps, most clearly shown in FIG. 2, may be performed by electronic circuitry, computers and/or processors disposed in mobile switching center 17. Subsequent to a calling party's initiating a call or message at step 200, the system 10 checks against the worldwide database 20 for prayer times at step 205. If the call occurs outside of prayer times, the call or message is sent through to the phone 25 at step 210. If the mobile phone 25 has an incoming call during prayer times, the mobile phone 25 is kept in a non-audible, non vibratory, non-visually distracting, standby mode and, step 215 is performed, wherein the caller is informed about the prayer time and the incoming call is diverted to telecommunications mail system 55 accessible to the user, thus allowing the user of the mobile phone 25 to continue devotional activities without being interrupted by the incoming call.

At step 220, a check is performed to determine whether prayer time is over. If the prayer time is not over, the system 10 waits at step 230. If the prayer time is over, the mobile switching center 17 performs step 225 to send a list of calls and messages that occurred during the prayer to the user of mobile phone 25. Incoming calls screened by the system 10 may include multimedia data, voice data and/or text data.

It will be noted that some cell phones or mobile phones are programmed to emit an audible alarm to notify the user that either a new voice mail message has been recorded in a voice mailbox, or to notify the user that an unread text message is stored in a text mailbox, when the user does not pick up the incoming call or message directly. According to the system and method of the present invention, the mobile switching center 17 is programmed to delay notification of pending messages in the subscriber's voice and text mailboxes until after the scheduled Muslim prayer times have expired.

It is to be understood that the present invention is not limited to the embodiment described above, but encompasses any and all embodiments within the scope of the following claims.

I claim:

1. A system for blocking incoming phone calls to a user's mobile station during devotional activities of the user, comprising:
a first mass storage unit;
worldwide prayer times stored in the first mass storage unit;
a second mass storage unit;
subscriber information stored in the second mass storage unit, the subscriber information including registration data for determining whether a user is subscribed to the call blocking system;
a call blocking controller in operable communication with the first and second mass storage units;
a cell site base station in operable communication with the call blocking controller and the mobile station;
a call blocking module connected to the call blocking controller, the call blocking module receiving caller communications from a telecommunications network, and a call diversion control signal from the call blocking controller;
a telecommunications mail system, the telecommunications mail system being connected to the call blocking module;
means for comparing local time of the mobile phone to a devotional prayer time in the worldwide prayer time database, a comparison between the mobile phone local time and the devotional prayer time being made if, based on the registration data, the user is subscribed to the phone blocking system, the call diversion signal being sent to the call blocking module to block the call from the mobile station and divert the call to the telecommunications mail system based on a result of said time comparison; and
means for keeping the mobile station in a non-audible, non vibratory standby mode when the incoming call is diverted, thereby allowing the user of the mobile station to continue devotional activities without being interrupted by the incoming call.

2. The system for blocking mobile phone calls according to claim 1, further comprising means for sending a prerecorded message from the telecommunications mail system to an originator of the incoming call advising the originator of the prayer time.

3. The system for blocking mobile phone calls according to claim 1, wherein the incoming call comprises multimedia data.

4. The system for blocking mobile phone calls according to claim 1, wherein the incoming call comprises voice data.

5. The system for blocking mobile phone calls according to claim 1, wherein the incoming call comprises text data.

6. The system for blocking mobile phone calls according to claim 1 further comprising means for sending all diverted messages and caller ID's stored in the telecommunications mail system through to the mobile station when the prayer time is over.

7. A computerized method for blocking mobile phone calls and messages, comprising the steps of:
storing a worldwide schedule of Muslim prayer times in a database;
determining the local time of a base station serving an intended recipient of a mobile phone call;
automatically comparing the recipient's local time to the schedule of Muslim prayer times recorded in the database; and
blocking the mobile phone call when the recipient' local time coincides with a schedule Muslim prayer time recorded in the database.

8. The computerized method for blocking mobile phone calls according to claim 7, further comprising the step of notifying the originator of the mobile phone call of the scheduled prayer time.

9. The computerized method for blocking mobile phone calls according to claim 8, further comprising the step of automatically switching the mobile phone call to a telecommunications mailbox when the mobile phone call is blocked.

10. The computerized method for blocking mobile phone calls according to claim 7, further comprising the step of sending a list of caller identification information for blocked calls to the recipient when the scheduled prayer time is over.
